(19) United States
(12) Patent Application Publication
(10) Pub. No.: US 2018/0063653 A1
(43) Pub. Date: Mar. 1, 2018

(54) METHOD AND A DEVICE FOR ADJUSTING A HEARING AID DEVICE

(71) Applicant: SIVANTOS PTE. LTD., Singapore (SG)

(72) Inventor: STEFAN ASCHOFF, ECKENTAL (DE)

(21) Appl. No.: 15/680,773

(22) Filed: Aug. 18, 2017

(30) Foreign Application Priority Data
Aug. 25, 2016 (DE) 10 2016 216 054.0

(51) Int. Cl. H04R 25/00

(52) U.S. Cl. CPC H04R 25/505; H04R 25/70; H04R 25/558

(57) ABSTRACT

For adjusting a hearing aid device, a user's hearing preference is generated as data that contain, in respect of the user's hearing experience, information about a problem. With reference to the hearing preference, modified auxiliary device parameters for the hearing aid device are calculated on the basis of former hearing aid device parameters of a hearing aid device, and on the user's personal data, by a computation algorithm, and are downloaded to the hearing aid device. A response, containing information as to whether or to what extent the modified hearing aid device parameters satisfy the hearing preference, is recorded. Depending on the hearing preference and on the response, the previous hearing aid device parameters and the modified hearing aid device parameters and/or parameter modifications through which the modified hearing aid device parameters differ from the previous hearing aid device parameters are archived as a data record in a user database.

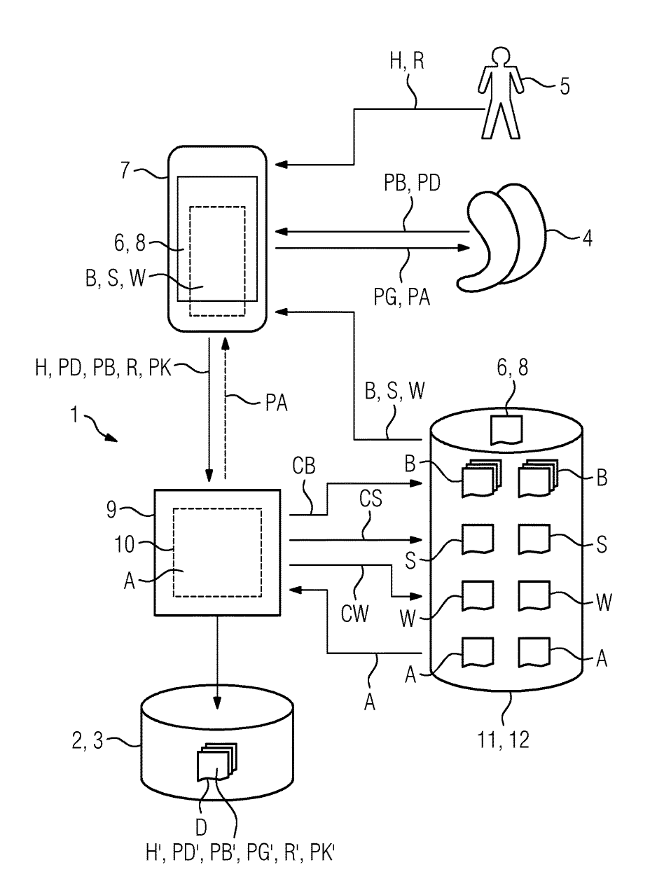

### CROSS-REFERENCE TO RELATED APPLICATION

This application claims the priority, under 35 U.S.C. § 119, of German application DE 10 2016 216 054.0, filed Aug. 25, 2016; the prior application is herewith incorporated by reference in its entirety.

### BACKGROUND OF THE INVENTION

### Field of the Invention

The invention relates to a method for adjusting a hearing aid device, i.e. for the user-specific adjustment of parameters of a hearing aid device, so that an optimized hearing experience is achieved for the user of the hearing aid device. The invention further relates to a device for carrying out the method.

“Hearing aid device” refers generally to a portable hearing apparatus whose purpose is to improve the perception of the ambient sound impinging on the ear of a user. A subclass of the hearing aid devices, referred to classically as “hearing devices”, is arranged to serve those with hearing impairments who suffer from hearing loss in the medical sense. In order to satisfy their numerous individual needs, different structural types of hearing aid devices, such as the behind-the-ear hearing devices (BTE), hearing devices with an external receiver (RIC, receiver-in-canal), in-the-ear hearing devices (ITE), as well as concha hearing devices or canal hearing devices (ITE, CIC), are offered. These examples of hearing devices listed are worn on the outer ear or in the auditory canal. In addition, bone conduction hearing aids, implantable or vibrotactile hearing aids, are also available on the market. In this case, the stimulation of the damaged hearing faculty is performed either mechanically or electrically.

In addition to the classic hearing devices described above, hearing aid devices to assist people with normal hearing have recently appeared. Such hearing aid devices are also referred to as “Personal Sound Amplification Products” or “Personal Sound Amplification Devices” (abbreviated to “PSAD”). These hearing aid devices are not provided to compensate for hearing losses. Such hearing aid devices are, rather, used precisely to assist and improve the normal human hearing capacity in specific hearing situations.

PSAD can, for example, be used to assist hunters out on the hunt, or during the observation of birds or bats, in order to be better able to perceive animal noises and other sounds generated by animals. PSADs are, moreover, being developed to permit improved speaking and/or speech understanding on the part of someone with normal hearing under difficult conditions, for example in “cocktail party” situations, or for sports reporters who want to telephone when in a stadium. A yet further application of PSADs is aimed at violinists, who want to attenuate the spectrally pure violin sound during their exercises, in order to reduce the long-term stress on their hearing.

All types of hearing aid device comprise an input transducer, an amplifier and an output transducer as important components. An acoustic-electrical converter, a microphone for example, and/or an electromagnetic receiver, an induction coil for example, is employed as a rule as the input transducer. The output transducer is usually realized as an electro-acoustic converter, for example as a miniature loudspeaker, or as an electro-mechanical converter, such as a bone conduction receiver. The amplifier is usually integrated into a signal processing device.

Hearing aid devices are fitted by the respective manufacturers with highly comprehensive processing mechanisms related to acoustic signal processing. By means of the values of a large number of parameters, the wide range of details of different signal processing properties, such as for example of the amplification, of the (dynamic) compression, of the directional microphone, of the lifting of the spectral region of speech, of the feedback suppression and of the suppression of interfering noise (for example the inherent noise of the microphone or wind noise) can be adjusted here.

The ability to parameterize modern hearing aid devices, as well as classic hearing devices and hearing aid devices for people with normal hearing, often with several thousand parameters, has advanced to a level of complexity that is comparable to the complexity of large medical devices such as those for computer tomography or magnetic resonance tomography. The majority of these parameters can only reasonably be adjusted by the manufacturer of the hearing systems. The parameter adjustment can, however, crucially affect the user's hearing experience (i.e. the hearing quality perceived by the carrier of the respective hearing aid device). Only a small proportion of the parameter values, such as for example the amplification, or a tone balance to emphasize higher and/or lower tones, is here at all comprehensible to—and reasonably adjustable by—the average user.

Classically, the user-specific adjustment (or customization) of the hearing aid device is carried out by a trained audiologist or hearing care professional (HCP) who, due to her training, understands the concepts of the acoustic signal processing such as amplification, dynamic compression, directivity index (a measure of how strong the directional effects of the microphone of a hearing system are), interfering noise reduction, or feedback suppression. The acoustic technician communicates with the wearer of the hearing system, understands the customer's complaints or preferences, and applies her knowledge in such a way that she adjusts the corresponding parameter values of the hearing system that constitute its signal processing properties appropriately. In the course of one or a plurality of customization sessions, the HCP iteratively changes the parameter values of the hearing aid device in order to find a parameter adjustment matched to the user.

But even for experts, the large number of adjustable parameters of a modern hearing aid device is only manageable with difficulty. This is also due to the fact that a good customization of hearing aid devices depends not only on the hearing capacities or the hearing loss of the wearer of the hearing system, but always also on a large number of other individual, personal properties such as interests, familiarization effects, cognitive capacities, the native language or the surroundings where the wearer of the hearing system is located (e.g. in nature or in front of a television).

In addition, the user is often unable to obtain a comprehensive or (i.e. for her overall living situation) representative sound impression in the context of a customization session. This is because the acoustic environment during a customization session cannot represent a large number of the situations from the life of the wearer of the hearing system. It is also known that those with hearing impairment must become used to a new hearing system over a period of weeks, since, in the presence of a hearing impairment, the brain loses, for example, the ability to understand speech bit by bit as time goes by. For this reason alone, it is usual for a sequence of several customization sessions to be required in order to make suitable readjustments, since the user must first learn to handle the restored hearing capacity bit by bit.

In addition, the mere restoration or improvement of the hearing capacity (that is the straightforward perception of sound) is often not the only criterion for the adjustment of the parameters of a hearing aid device. It is also of importance for many users that the effort that they must apply to understand speech is as low as possible. At present it is only normally possible to find out which parameter adjustments minimize the effort of hearing for an individual user through prolonged trials.

In the light of the complications described above with the adjustment of hearing aid devices, a process involving collaboration between the audiologist interacting with the user and the manufacturer of the hearing aid devices has become established in practice. The manufacturer here makes available a catalogue of typical hearing preferences that wearers of hearing systems express to their HCP. Each one of these hearing preferences deals with the topic of a frequently recurring concrete complaint on the part of users, that is to say a description of a typical problem related to the user's sense of hearing (such as, for example, “speech too quiet”, “sound too muffled” or, however, “sound too bright/too metallic”, “frequent occurrence of feedback”, and many more) or—equivalently—a desire for improvement (such as for example “speech louder”, etc.).

The manufacturer now prepares computation algorithms for each such hearing preference, which modify the adjustments of the signal processing properties according to the hearing preference. Such computation algorithms can perfectly well be so configured that they take the individual peculiarities of the user into account: If, for example, the amplification is to be increased, the optimum step size of this increase can be greater for people with a slight loss of hearing than for people with a heavy loss of hearing; for the latter, only a small range is available between the threshold of hearing and the discomfort threshold.

These computation algorithms are now supplied to the HCPs along with customization software, so that these can execute the computation algorithms in the course of a customization session. In the customization software, the HCP selects the hearing preference that she learns from her patient, and carries out the corresponding computation algorithm.

The use of such computation algorithms has the advantage that the manufacturer can incorporate into them all their knowledge of the special signal processing properties of the hearing aid device. The computation algorithms thus usually also modify the special, manufacturer-specific signal processing properties that are not known in detail to the average audiologist.

The computation algorithms are used by the audiologist for a preliminary customization of the parameters. The parameters calculated by the respective computation algorithm are then only fine-tuned by the audiologist when required.

Through the facility for fine-tuning, the audiologist can integrate her professional experience, or a personal “differential diagnostics”, i.e. the impressions directly in front of her, for the benefit of her patients.

As effective as this method may be, it is nevertheless always still time-consuming and expensive. In particular, the preparation of the computation algorithms causes a substantial amount of work for the manufacturer of the hearing aid device.

### SUMMARY OF THE INVENTION

The invention is therefore based on the object of enabling an effective adjustment of a hearing aid device which, however, entails relatively small effort.

The method according to the invention for adjusting a hearing aid device includes the now described steps.

A user's hearing preference is generated. The hearing preference is here generated in the form of data that contain, in respect of the user's hearing experience, information about a concrete, existing problem and/or about desired improvement.

With reference to the hearing preference, on the basis of former hearing aid device parameters (referred to as HG parameters below for short) of a hearing aid device assigned to the user, and on the basis of the user's personal data, modified HG parameters for the hearing aid device are calculated by a computation algorithm. The hearing preference is, for example, generated through selection from a prescribed list of hearing preferences, or through formulation as free text with subsequent automatic text analysis and automatic assignment to one of a plurality of prescribed hearing preference classes. The feature of “with reference to the hearing preference” is, in a preferred embodiment of the method, implemented in that one or more separate computation algorithms are provided for each hearing preference or for each hearing preference class, and are applied to the corresponding respective hearing preference. In an equivalent, alternative embodiment of the method, a case distinction or weighting is undertaken in the context of a single computation algorithm, depending on the hearing preference.

The modified HG parameters are downloaded to the hearing aid device.

At a later point in time, a response, containing information as to whether or to what extent the modified HG parameters satisfy the hearing preference, is recorded. The response thus indicates whether, or to what extent, the problem expressed by the user has been solved or whether, or to what extent, the desired improvement has been achieved. The “later point in time” at which the response is recorded is, in particular, the next point in time after a minimum period of time (of, for example, a week) at which the hearing aid device, following the download of the modified HG parameters calculated by the computation algorithm (in particular via an associated configuration unit such as, for example, a smartphone app or a customization station of the acoustic technician) is connected for data transfer with the user database. The minimum period of time is preferably matched to an active time (familiarization time) determined in advance from experiential values, which typically passes by after the application of the respective computation algorithm until the full development of its effect. The specified minimum period of time for different computation algorithms is, accordingly, usually specified differently. In the case of computation algorithms which experience has shown to only develop their full effect after a certain plurality of repeated applications, the corresponding multiple active time is preferably included in the calculation of the minimum time span.

In the simplest case, the response consists of a binary statement with which the user accepts or declines the modified HG parameters calculated by the computation algorithm. As an alternative to this, a quantitative form of feedback is provided which is formed of a multi-stage evaluation with which the user evaluates the modified HG parameters calculated by the computation algorithm, for example on a scale from 1 to 5, in respect of the fulfillment of the hearing preference. As the response at the later point in time it is preferably determined whether the user has adopted the modified HG parameters calculated by the computation algorithm unchanged, or whether she has made manual fine-tunings. This form of response is preferably collected automatically, i.e. without the user's conscious assistance. A binary data entry, which can adopt one of the two values of “adopted unchanged” and “fine-tuned”, is, for example, archived here in the user database as a response. The response can further, within the scope of the invention, also comprise a combination of the types of response described above.

Finally, depending on the hearing preference and on the response the previous HG parameters, the modified HG parameters and/or parameter changes through which the modified HG parameters differ from the previous HG parameters, together with the user's personal data are archived as a data record in a user database. Alternative HG parameters are determined for the user with reference to the user database (i.e. by evaluating the data records archived in the user database), in particular in the case of a negative response. Alternatively or in addition, changes for the computation algorithm are determined on the basis of the user database. The determination of the alternative HG parameters, or the changes for the computation algorithm, are preferably determined automatically (i.e. without human interaction). Optionally, however, a manual inspection step is provided here, in the course of which the automatically determined alternative HG parameters or changes for the computation algorithm are accepted or discarded by an expert.

The feature of “depending on the hearing preference” is, in a preferred embodiment of the method, implemented in that the hearing preference, or the hearing preference class, is adopted as a data entry in the archived data record—in this case the user database contains data records for all the specified hearing preferences or hearing preference classes. Alternatively, for each hearing preference or each hearing preference class, a dedicated user database is managed, wherein the “depending on the hearing preference” data records are assigned to these user databases.

The feature of “depending on the response” is, in a preferred embodiment of the method, implemented in that the response (e.g. in the form of a binary, multi-level or continuous evaluation) is adopted as a data entry into the archived data record—in this case the user database contains data records for positive and negative responses. Alternatively, only data records with a positive response (or, alternatively, only data records with a negative response) are archived in the user database—data records with the respective other response are, in the latter case, discarded depending on the response.

In a preferred embodiment of the method, the HG parameter can be corrected manually by the user or the acoustic technician (audiologist). At the later point in time here, it is preferably determined, in order to record the response, whether the modified HG parameters calculated by the computation algorithm were installed in the hearing aid device unchanged, or whether they were manually fine-tuned. In the case of manual fine-tuning, the fine-tuned HG parameters are additionally archived in the data record in the user database.

In a further preferred embodiment of the method, the data records contained in the user database are subjected to a cluster analysis, in order to determine whether the data records, depending on the hearing preference and the response, and in respect of a subgroup of the HG parameters and personal data, divide into statistically distinguishable clusters. On establishing such a clustering, a modified or extended rule that takes this clustering into account is generated, in particular automatically, for the computation algorithm.

As a modified or extended rule, here—in particular again automatically—a case distinction is generated for the computation algorithm through which, depending on one or a plurality of the personal data, varying parameter changes are specified for one or a plurality of the HG parameters.

The case-specific changes to the computation algorithm are preferably determined through the formation of mean values or through (linear or non-linear) customization (fitting) to a subgroup of the data records contained in the user database which reflect the determined clustering. If, for example, it is determined in the cluster analysis that Italian-speaking users prefer different parameter changes in respect of a particular hearing preference from those suggested by the existing computation algorithm, a new case distinction for Italian-speaking users and non-Italian-speaking users is added to the computation algorithm. The properties of the computation algorithm for the first case (i.e. for Italian-speaking users) are determined, in that mean values are formed over archived data records from Italian-speaking users, or in that the computation algorithm, for example using the Levenberg-Marquardt method, is “fitted” to the archived data records of the Italian-speaking users. For the second case (i.e. for the non-Italian-speaking users), the previous properties of the computation algorithm are, for example, retained unchanged.

In order to prevent the computation algorithm adopting a size that is difficult to handle numerically as a result of repeated addition of new case distinctions, different cases are mapped in an expedient variant of the method onto different subsidiary algorithms which can, however, be executed independently. The case distinction is here preferably implemented in a superordinate prognosis algorithm which, depending on the HG parameters relevant for the case distinction and/or personal data, selects the respectively assigned subsidiary algorithm. In a further development of the method, it is provided that a plurality of subsidiary algorithms are selected and carried out in parallel, the respective (weighted or unweighted) results of which are subsequently averaged.

The personal data processed and archived in the course of the method preferably comprises information relating to the hearing loss, the age, the size, the gender, the language knowledge (e.g. information on the first language as well as, optionally, to multi-lingual facility or knowledge of foreign languages), the nationality, and to any illnesses and/or disabilities of the user.

The HG parameters determined and archived in the course of the method preferably comprise information on frequency-dependent amplification factors, on a compression, on an interfering noise suppression (in particular on the strengths and the frequency-dependent properties of the interfering noise suppression), on the directional characteristic of the microphone contained in the hearing aid device or of microphones contained in the hearing aid device, on the application of a feedback suppression (in particular on the strength of the feedback suppression) and or on a classification of hearing situations.

The method is, however, not restricted to the said personal data and HG parameters. It is rather possible for a large number of further personal data and HG parameters (from the beginning onward, or successively in the course of carrying out the method) to be included in the method. In particular the user database is preferably arranged so that, without restructuring the user database, data records that have already been archived can be extended by further HG parameters and/or personal data, and that new data records, which comprise an extended set of HG parameters and/or personal data in comparison with the data records already archived, can be archived.

In a further preferred embodiment of the method, in particular in the case of a negative response, the archived data record of a different user is selected from the user database which, taking into account the hearing preference, the personal data and the former HG parameters, comes closest to the corresponding data of the user. The modified HG parameters of this selected, archived data record are adopted as alternative HG parameters for the user. Preferably, here only archived data records with a positive response or, if relevant, with successful manual fine-tuning, are taken into account.

In a variant of the previously described form of embodiment of the method, the alternative HG parameters are not determined from one, most similar, archived data record, but from a plurality of similar data records, wherein these similar, archived data sets are averaged over the modified HG parameters. Thus, in particular in the case of a negative response, a number of archived data records of other users are selected from the user database which, taking into account the hearing preference, the personal data and the former HG parameters, come closest to the corresponding data of the user. The (weighted or unweighted) mean values of the modified HG parameters of this selected, archived data record are here determined as alternative HG parameters for the user. Preferably again, here only archived data records with a positive response or, if relevant, with successful manual fine-tuning, are taken into account.

The device according to the invention is in general arranged for carrying out the above-described method, in particular in one of the described variant embodiments. The above-described forms of embodiment of the method thus each find their equivalent in a corresponding form of embodiment of the device.

Concretely, the device contains a user database, in which a large number of data records of various users are archived. Each data record, depending on the respectively underlying hearing preference and the associated response contains the previous HG parameters and the modified HG parameters and/or parameter changes through which the modified HG parameters differ from the previous HG parameters, together with the user's personal data a software repository, in which at least the computation algorithm and an evaluation algorithm are made available. The computation algorithm is arranged to calculate modified HG parameters for the hearing preference of a specific user, on the basis of previous HG parameters of a hearing aid device assigned to this user, and on the basis of personal data of this user. The evaluation algorithm is arranged to determine, from the user database, alternative HG parameters for the user and/or changes for the computation algorithm. A configuration unit is provided that can be connected for data transfer to the hearing aid device of the user, in order to download the modified HG parameters calculated by the computation algorithm into the hearing aid device. The configuration unit is arranged to generate the hearing preference, to register the response after downloading the modified HG parameters calculated by the computation algorithm and to transfer the hearing preference, together with the response, the previous HG parameters, the modified HG parameters and/or parameter modifications through which the modified HG parameters differ from the previous HG parameters, as well as the personal data of the user (directly or indirectly through further components of the device) to the user database for archiving, a (first) runtime environment for carrying out the computation algorithm, into which the computation algorithm can be loaded from the software repository, and a (second) runtime environment for carrying out the evaluation algorithm, into which the evaluation algorithm can be loaded from the software repository.

The configuration unit can be designed, within the framework of the invention, as a hardware device, e.g. as a dedicated handheld device for programming the hearing aid device. Preferably, however, the configuration unit is a software module, e.g. in the form of an app that is arranged to run on an electronic data processing device of the user (e.g. a computer, smartphone or tablet), and which uses the hardware of the data processing device, e.g. a Bluetooth transceiver, to establish a connection for data transfer with the hearing aid device.

The (first) runtime environment for carrying out the computation algorithm is, in particular, an item of so-called middleware, i.e. a software platform that is installed on the operating system of a computer or other program-control device, and on which, in turn, the computation algorithm can be carried out. The first runtime environment is here integrated, in particular into the configuration unit, e.g. the above-described smartphone app.

The (second) runtime environment for carrying out the evaluation algorithm is in particular implemented on a central server, preferably in a cloud computing center. The second runtime environment can within the framework of the invention also be middleware. Alternatively, the evaluation algorithm runs directly on the server, so that the (second) runtime environment is formed by the operating system of the server.

Preferably the HG parameters—as described above—can be manually fine-tuned by the user or an acoustic technician (audiologist) through the configuration unit. The configuration unit is here preferably arranged for recording the response, to determine whether the modified HG parameters calculated by the computation algorithm were installed in the hearing aid device unchanged, or whether they were manually fine-tuned, in the case of manual fine-tuning, to transfer in addition the fine-tuned HG parameters for archiving to the user database.

Preferably the evaluation algorithm is arranged to subject the data records contained in the user database to the above-described cluster analysis to generate the extended rule for the computation algorithm.

Other features which are considered as characteristic for the invention are set forth in the appended claims.

Although the invention is illustrated and described herein as embodied in a method and a device for adjusting a hearing aid device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is an illustration showing a device for adjusting parameters of a hearing aid device of a user.

### DETAILED DESCRIPTION OF THE INVENTION

Referring now to the single FIGURE of the drawing in detail, there is shown a device 1 which has:
a) a database server 2 with a user database 3 in which a large number of datasets D are archived,
b) a number of computation algorithms B for adjusting the signal processing properties of a hearing aid device 4 of a user 5, namely for calculating changed HG parameters PG,
c) a number of prognosis algorithms S for the prognosis of the optimum selection of the matching computation algorithm B,
d) optionally, a number of prognosis algorithms W for the prognosis of the optimum effectiveness of the respective computation algorithm B when carried out multiple times,
e) a number of evaluation algorithms A, which are on the one hand arranged for the calculation of alternative HG parameters PA for the user and, on the other hand, for the calculation of changes CB, CS and CW for the computation algorithms B, the prognosis algorithms S or the prognosis algorithms W,
f) a configuration unit in the form of a (configuration) app 6 that is intended to run on an electronic data processing device (in this case a smartphone 7) of the user, in order, through carrying out one of the computation algorithms B to calculate the changed HG parameters PG for the hearing aid device 4,
g) a first runtime environment 8 for carrying out the computation algorithms B, which, in the example according to the FIGURE, is implemented as a part of the app 6,
h) a server 9 with a second runtime environment 10 for carrying out the evaluation algorithms A, and
i) a server 11 with a software repository 12, i.e. a managed directory in which program packages and associated metadata, namely in the present case the algorithms B, S, W, A and the app 6 are made available for downloading to the smartphone 7 or to the server 9.

Like the hearing aid device 4 and the user 5, the smartphone 7 is not part of the device 1. Rather, the smartphone 7, the hearing aid device 4 and the user 5 merely interact with the above-mentioned components of the device 1. These components of the device 1 are preferably (like, for example, the database server 2 with the user database 3, the server 9 with the second runtime environment 10, and the server 11 with the software repository 12) installed in a cloud data center or distributed over a plurality of data centers of a cloud or are (like, for example, the app 6 with the first runtime environment 8 and the algorithms B, S and W) made available for downloading onto the smartphone 7. The server 9 is connected to the database server 2 and the server 11, for example over a data transfer network internal to the cloud. Optionally, a plurality of the components of the device 1 illustrated in the FIGURE are also integrated into larger units. The servers 2, 9 and 11 can, for example, also be brought together into one unit. The smartphone 7 is connected over the Internet to the server 9 and the software repository 12.

Each of the data records D integrated into the user database 3 contains information (data entries) about:
a) an expressed hearing preference H′ of another user (different, as a rule, from the user 5),
b) personal data PD′ of the other user,
c) the previous HG parameters PB′ of a hearing aid device (usually corresponding to the hearing aid device 4) of the other user, which gave reason to express the hearing preference H′,
d) modified HG parameters PG′ that were calculated by one of the computation algorithms B with reference to the hearing preference H′ as well as the personal data PD′ and the previous HG parameters PB′ of the other user,
e) a response R′, which indicates whether the hearing preference H′ was satisfied by the modified HG parameters PG″, and
f) any HG parameters PK′ that may have been manually fine-tuned by the other user.

Optionally, the data record D contains further data entries, for example:
a) a repetition number, which indicates how often the computation algorithm B was repeated in order to reach the modified HG parameters PG′, and/or the waiting time between the repetitions,
b) an indication of whether the other user followed recommendations of the app 6 with respect to the computation algorithm B to be used and/or of the repetition scheme for the application of the computation algorithm B, and
c) a statement of the computation algorithm B used.

In addition to the app 6, a number of computation algorithms B (i.e. one computation algorithm B or a plurality of computation algorithms B), as well as, in each case, an associated prognosis algorithm S, an associated prognosis algorithm W and an associated evaluation algorithm A are stored in the software repository 12 for each hearing preference H. The FIGURE illustrates by way of example, for two hearing preferences, in each case such a set of associated algorithms B, S, W and A, the algorithms B, S, W and A that belong to one another being in each case illustrated one above another. In the intended application, the software repository 12 contains such a set of algorithms B, S, W and A for each of a large number of hearing preferences H.

In an alternative embodiment, a common prognosis algorithm S, a common prognosis algorithm W and/or a common evaluation algorithm A can also be held for all hearing preferences H. A plurality of computation algorithms B can also, in an alternative embodiment of the invention, be grouped together into a superordinate computation algorithm B (hearing-wish specific or extending universally over hearing preferences).

To use the device 1, the user 5 first downloads the app 6 from the software repository 12 onto the smartphone 7.

The app 6 uses a Bluetooth receiver of the smartphone 7 in order to connect itself to the hearing aid device 4 of the user 5 for data transfer and, if possible, to the user 5, in order to modify the HG parameters of the hearing aid device 4 (or, preferably, a selected subset of these HG parameters) through interaction with the app 6 via the smartphone 7.

If the previous HG parameters PB of the hearing aid device 4 lead to a hearing experience that is unsatisfactory for user 5, the user 5, by interacting with the app 6 via the smartphone 7, expresses a hearing preference H, in that she selects an entry corresponding to her problem from a list specified by the app 6.

The app 6 thereupon loads the previous HG parameters PB, as well as the personal data PD of the user 5, from the hearing aid device 4. In addition, it downloads the prognosis algorithm S corresponding to the hearing preference H from the software repository 12, and starts this prognosis algorithm S executing in the runtime environment 8.

The prognosis algorithm S analyses the previous HG parameters PB as well as the personal data PD of the user 5, and on this basis suggests to the user 5 what, according to its internal specifications, is the most suitable computation algorithm B (from the group of computation algorithms B assigned to the hearing preference H).

Through interaction with the app 6 via the smartphone 7, the user 5 can confirm the suggested computation algorithm B or can select another computation algorithm B assigned to the hearing preference H. The confirmed or selected computation algorithm B is downloaded by the app 6 from the software repository 12, and made to execute in the run-time environment 8.

The computation algorithm B here calculates modified HG parameters PG on the basis of the previous HG parameters PB as well as of the personal data PD of the user 5. These modified HG parameters PG are then loaded by the app 6 into the hearing aid device 4, making use of the Bluetooth receiver of the smartphone 7.

In addition, the app 6 also downloads the prognosis algorithm W corresponding to the hearing preference H from the software repository 12, and starts this prognosis algorithm W executing in the runtime environment 8.

Depending on the computation algorithm B used as well as with reference to the previous HG parameters PB and the personal data PD of the user 5, the prognosis algorithm W calculates a repetition scheme that is optimum according to its internal specifications, which contains information on a number of repetitions for the repeated execution of the computation algorithm B used and the optimum waiting time between the repetitions. In isolated cases, the number of repetitions here can also be zero. Optionally, the prognosis algorithm W also automatically triggers the repeated execution of the computation algorithm B used in accordance with the repetition scheme determined, or at least reminds the user 5 about the execution of the computation algorithm B in accordance with this repetition scheme.

During and after performance of the prognosis algorithm W (and thereby during or after the repeated execution of the computation algorithm B) the user 5 can manually fine-tune the HG parameters of the hearing aid device 4 through interaction with the app 6 via the smartphone 7. The user 5 can, moreover, also interrupt the execution of the prognosis algorithm W ahead of schedule.

After execution of the recommended repetition scheme, or if the user 5 interrupts the performance of the prognosis algorithm W, then after a waiting time specified by the prognosis algorithm W, depending on the computation algorithm B used, the app 6 asks the user 5 through the smartphone 7 to submit a response R. The waiting time can be interrupted by the user 5.

The response R contains a binary indication of whether the user 5 wants to adopt the HG parameters PG that have been modified by the computation algorithm B (positive response) or decline them (negative response). If the user 5 declines the modified HG parameters PG, and if the user 5 has manually fine-tuned the HD parameters since the first execution of the computation algorithm B, the app 6, in interaction with the user 5, either retains the fine-tuned HG parameters PK on the hearing aid device 4, or restores the previous HG parameters PB.

Both in the case of a negative response and of a positive response, the app 6 transfers the hearing preference H together with the personal data PD of the user 5, the previous HG parameters PB of the hearing aid device 4, the modified HG parameters PG calculated at the last repetition by the computation algorithm B, the response R, and the HG parameters PK, if any, that have been manually fine-tuned by the user 5 as well as, in relevant cases, further information (e.g. the number of repetitions and the waiting time, an indication of the acceptance or rejection of suggestions from the app 6 by the user 5, and/or information about the algorithm used) to the server 9, which archives this data as a new dataset D in the user database 3.

If the response R is negative, the server 9 downloads the evaluation algorithm A corresponding to the hearing preference H from the software repository 12, and starts this evaluation algorithm W executing in the runtime environment 10.

The evaluation algorithm A is divided into two partial algorithms, which can be executed entirely independently of one another and which are therefore implemented as separate algorithms in modified forms of embodiment of the device 1.

A first partial algorithm of the evaluation algorithm A searches the user database 3, depending on the hearing preference H, for archived data records D of other users with positive response R′, which come on the whole closest to the personal data PD of the user 5 and to the previous HG parameters PB of the hearing aid device 4. The first partial algorithm forms mean values of the modified HG parameters PG′ from a particular number (e.g. from ten) of the data records D found in this way that exhibit the greatest similarity to the said data of the user 5, and transfers these mean values as alternative HG parameters PA to the app 6.

The alternative HG parameters PA are then loaded by the app 6 using the Bluetooth receiver of the smartphone 7 on to the hearing aid device 4, provided the user 5 agrees to adopt them.

The second partial algorithm (also known as the customization algorithm) of the evaluation algorithm A subjects the data records of other users archived in the user database 3 to a cluster analysis. In the course of the cluster analysis, a check is, in particular, made as to whether the distribution of the values of specific modified or fine-tuned HG parameters (in particular when the type of response R′ is the same) over particular personal data PD′ and/or other HG parameters (in particular the previous HG parameters PB′) divide into statistically distinguishable clusters. If such a cluster is found here, the second partial algorithm automatically creates a new computation algorithm B for the hearing preference concerned, in that it newly customizes the variables of the existing computation algorithm B, using an optimization method (fit) in the light of those archived data records D that form the found cluster.

The evaluation algorithm A loads the newly created computation algorithm B as a change CB into the software repository 12.

With a change CS, the evaluation algorithm A inserts a new case distinction into the prognosis algorithm S, so that in future the prognosis algorithm S proposes the newly prepared computation algorithm B for personal data PD and/or HG parameters that correspond to the cluster that has been determined.

Furthermore, with a change CW, the evaluation algorithm A also customizes the prognosis algorithm W, so that this prognosis algorithm W proposes suitable repetition numbers and waiting times for the computation algorithm B.

The performance of the customization algorithm (i.e. the second partial algorithm of the evaluation algorithm) is preferably also triggered by other events, e.g. through the lapsing of a certain period of time, through the growth of the user database 3 by predetermined number of data records D, through manual instigation etc.

According to another form of embodiment of the device 1, the whole of the software repository 12 (although without the evaluation algorithms A) is always supplied to the runtime environment 8. The user 5 can thus also perform the algorithm-supported calculation of the modified HG parameters off-line, namely when the smartphone 7 does not have a connection to the Internet.

The transmission of the user data and user reactions into the user database 3 takes place with a time delay in this case, when the smartphone 7 again has an Internet connection.

In a further form of embodiment, it is provided that an additional processing step is performed.

The customization algorithms do not here append their modifications directly to the computation and prognosis algorithms B, S, W, which are stored in the software repository 12. The results of the customization algorithms are, rather, put into visual form, and displayed to an expert for hearing system customizations (in particular an employee of our manufacturer of hearing aid devices). In respect of the changes CB, CS and CW, the expert is here given the options of accepting them, modifying and then accepting them, or using them as a template for application cases or patient features for which, until that stage, no computation or prognosis algorithms have been saved.

In all the variants of the device 1 described above and of the method carried out by these, it is possible, instead of the changed HG parameters PG or instead of the fine-tuned HG parameters PA, for parameter changes also to be archived and analyzed, in order to distinguish the modified or fine-tuned HG parameters PG, PK from the previous HG parameters PB.

Three exemplary cases for the use of the device 1 and of the method performed by it are described below. To illustrate the effect of the invention, these examples have been deliberately chosen so that the underlying relationships are easily understandable to an expert. The true advantage of the invention in its practical application, on the other hand, is that through the application of the method according to the invention possibilities for an improved adjustment of hearing aid devices can be found whose causal relationships are not recognizable, nor appear plausible, even to the expert.

### EXAMPLE 1

Users in France, Italy and Germany have access to the software repository. A large number of users there select the statement “Speech is too quiet” from the hearing preference catalogue.

The computation algorithm is already stored for this hearing preference, which slightly raises the amplification in the frequency range between 1 kHz and 4 kHz. Many users employ this computation algorithm. A portion of these users perform a further fine-tuning on the amplification settings. The execution of this usage, and also the fine-tunings, are stored in the user database 3.

After receipt of 1000 usages (and the saving of 1000 corresponding data records D in the user database 3), the customization algorithm, which is arranged for the computation algorithm “Raise amplification in the frequency range between 1 kHz and 4 kHz”, is activated. This searches the available data records D for relationships. At first the fine-tunings do not appear to be significant: fine-tunings are present, but they do not yield a consistent picture.

However, as the analysis is performed with a differentiation according to the native language, the following picture emerges:

Users from France have additionally raised the amplification in the frequency range between 1 kHz and 2 kHz with their fine-tunings; and

Users from Italy have raised the amplification in the frequency range between 2 kHz and 4 kHz with their fine-tunings.

The picture arises since the variance (scatter) in the fine-tunings is comparatively small when compared to the mean value of the fine-tunings.

The customization algorithm supplements the computation algorithm B in such a way that the amplification between 1 kHz and 2 kHz is additionally raised for users with French as their native language. The amplification between 2 kHz and 4 kHz is additionally raised for users with Italian as their native language.

This example is based on the circumstance, understandable to the expert, which the dominant frequencies in the French language lay between 1 kHz and 2 kHz, whereas the dominant frequencies in the Italian language on the other hand are between 2 kHz and 4 kHz.

### EXAMPLE 2

Out of the list of typical complaints provided by the app 6, many users select the statement that sudden background noises, such as a spoon striking against a coffee cup, are experienced as uncomfortable.

A computation algorithm B directed at this hearing preference is designed such that it makes small changes to a large number of HG parameters of the hearing aid device 4. The computation algorithm, however, works universally, i.e. the same for every user, due to the absence of expert knowledge about the dependency of the optimum step size of the parameter changes on particular personal data PG. The preset parameter changes are, cautiously, of such small dimensions, that a simple execution of the computation algorithm only slightly changes disturbances that are visible on the time diagram of the volume as “needle-like” peaks.

After 1000 users have employed this computation algorithm, the associated customization algorithm performs analysis. This shows that in most cases the users have left it at a simple execution.

Those with a hearing impairment, whose hearing capacity is reduced by more than 60 dB in the high-pitched range, have however, used the computation algorithm B multiple times with statistically noticeable frequency, on average 3 times in a row, and have thereby reduced the pulse-shaped interfering noises more strongly than the majority of users.

The customization algorithm therefore adjusts the prognosis algorithm W in such a way that it gives those with a hearing impairment with a hearing loss of more than 60 dB in the high-pitched range the suggestion that they carry out the computation algorithm B three times.

This example is based on the circumstance, understandable to the expert, that pulse-shaped interference such as the impact of a spoon on the coffee cup, is experienced as much more uncomfortable to those with a hearing impairment than to those with normal hearing. It is therefore probable that those with a hearing impairment with a high level of hearing loss need a stronger suppression of such pulses than those with better hearing.

### EXAMPLE 3

Users in Europe and China have access to the software repository.

In this case many users select the statement “High tones, such as the clatter of crockery when washing up, are uncomfortable, too shrill” as hearing preference H.

Two alternative computation algorithms B are stored for this hearing preference H.

The first computation algorithm B increases the dynamic compression in the upper frequency range.

The second computation algorithm B reduces the amplification in the upper frequency range.

By default, the prognosis algorithm S suggests the first computation algorithm B. Many users try out the effect of the two computation algorithms, and then decide in favor of one of the two.

The selection of which competition algorithm B is now employed is stored with the hearing preference H in the patient history in the user database 3.

After 1000 users have made use of an improvement for this hearing preference H, the customization algorithm analyses the selection of the cases of this hearing preference H accumulated up to that stage.

The analysis yields the result that the majority of users with Chinese as a native language prefer the second computation algorithm B to the first. The customization algorithm thereupon changes the prognosis algorithms S in such a way that the second computation algorithm B is suggested by default to users with Chinese as a native language.

In a conceivable embodiment, the prognosis algorithm S makes use of a table in which the relative frequencies of the selections are entered. To achieve the above-described effect, the customization algorithm extends the table in such a way that from now on a differentiation according to the native language is inserted.

This example is based on the circumstance, understandable to the expert, that experience has shown that users who speak a so-called tonal language, e.g. Chinese, frequently prefer a signal processing with the least possible dynamic compression.

The invention is made particularly clear through the above-described examples of embodiment and case, but is nevertheless not limited to them. Rather, further forms of embodiment of the invention can be derived from the claims and the above description.

The following is a summary list of reference numerals and the corresponding structure used in the above description of the invention:

1 Device

2 Database server

3 User database

4 Hearing aid device

5 User

6 App

7 Smartphone

8 (First) runtime environment

9 Server

10 (Second) runtime environment

11 Server

12 Software repository

A Evaluation algorithm

B Computation algorithm

CB Change

CS Change

CW Change

D Data records

H, H′ Hearing preference

PA, PA′ (Alternative) HG parameters

PB, PB′ (Previous) HG parameters

PD, PD′ Personal data

PG, PG′ (Modified) HG parameters

PK, PK′ (Fine-tuned) HG parameters

R, R′ Response

S Prognosis algorithm

W Prognosis algorithm

1. A method for adjusting a hearing aid device, which comprises the steps of:
generating a hearing preference of a user in a form of data that contain, in respect of a hearing experience of the user, information about a problem and/or about desired improvement;
calculating modified auxiliary hearing aid device parameters for the hearing aid device by means of a computation algorithm with reference to the hearing preference, on a basis of previous hearing aid device parameters of the hearing aid device assigned to the user, and on a basis of personal data of the user;
downloading the modified auxiliary hearing aid device parameters to the hearing aid device;
recording a response, at a later point in time, containing information as to whether or to what extent the modified auxiliary hearing aid device parameters satisfy the hearing preference;
depending on the hearing preference and the response, archiving the previous hearing aid device parameters and the modified auxiliary hearing aid device parameters and/or parameter changes in which the modified auxiliary hearing aid device parameters differ from the previous hearing aid device parameters, together with the personal data of the user as a data record in a user database; and
determining alternative hearing aid device parameters for the user and/or changes for the computation algorithm.

2. The method according to claim 1, which further comprises:
fine-tuning manually the previous hearing aid device parameters by the user or by an acoustic technician;
determining, at a later point in time, for recording the response, whether the modified auxiliary hearing aid device parameters calculated by the computation algorithm were installed in the hearing aid device unchanged, or whether they were manually fine-tuned; and
archiving, in a case of manual fine-tuning, fine-tuned hearing aid device parameters in a data record in the user database.

3. The method according to claim 1, which further comprises subjecting data records contained in the user database to a cluster analysis, to determine whether the data records, depending on the hearing preference and the response, and in respect of a subgroup of the previous hearing aid device parameters and the personal data, divide into statistically distinguishable clusters, and wherein, on establishing such a clustering, a modified or extended rule that takes the clustering into account is generated for the computation algorithm.

4. The method according to claim 3, which further comprises generating a case distinction, as the modified or extended rule, for the computation algorithm through which, depending on at least one said personal data, varying parameter changes are specified for at least one of the previous hearing aid device parameters.

5. The method according to claim 1, wherein the personal data contains information on a hearing loss of the user, on age of the user, on size of the user, on gender of the user, on language knowledge of the user, on nationality of the user, on illnesses of the user and/or on disabilities of the user.

6. The method according to claim 1, wherein the previous hearing aid device parameters contain information on frequency-dependent amplification factors, on a compression, on an interfering noise suppression, on a directional characteristic of a microphone contained in the hearing aid device or of microphones contained in the hearing aid device, on a feedback suppression and/or on a classification of hearing situations.

7. The method according to claim 1, wherein:
in a case of a negative response, an archived data record of a different user is selected from the user database which, taking into account the hearing preference, the personal data and the previous hearing aid device parameters comes closest to corresponding data of the user; and
the modified auxiliary hearing aid device parameters of the archived data record selected are adopted as the alternative hearing aid device parameters for the user.

8. The method according to claim 1, wherein:
in a case of a negative response, a number of archived data records of other users are selected from the user database which, taking into account the hearing preference, the personal data and the previous hearing aid device parameters come closest to corresponding data of the user; and
weighted or unweighted mean values of modified auxiliary hearing aid device parameters of the archived data record selected are adopted as the alternative hearing aid device parameters for the user.

9. A device for adjusting a hearing aid device, comprising:
a patient database having a large number of data records of various users being archived, wherein each data record, depending on a respectively underlying hearing preference and an associated response, contains:
previous hearing aid device parameters; and
modified hearing aid device parameters and/or parameter changes in which the modified hearing aid device parameters differ from the previous hearing aid device parameters, together with the personal data of the user;
a software repository, in which at least a computation algorithm and an evaluation algorithm are made available, wherein the computation algorithm calculates modified hearing aid device parameters for the hearing preference of a user, on a basis of previous hearing aid device parameters of the hearing aid device assigned to the user, and on a basis of personal data of the user, and wherein the evaluation algorithm determines, from the user database, alternative hearing aid device parameters for the user and/or changes for the computation algorithm;
a configuration unit that can be connected for data transfer to the hearing aid device of the user, in order to download the modified hearing aid device parameters calculated by the computation algorithm into the hearing aid device, wherein the configuration unit is programmed to:
generate the hearing preference;
register a response after downloading the modified hearing aid device parameters calculated by the computation algorithm; and
transfer the hearing preference, together with the response, the previous hearing aid device parameters, the modified hearing aid device parameters and/or the parameter changes through which the modified hearing aid device parameters differ from the previous hearing aid device parameters, and the personal data of the user to the user database for archiving; and
a runtime environment for carrying out the computation algorithm, into which the computation algorithm can be loaded from said software repository, said runtime environment for carrying out the evaluation algorithm, into which the evaluation algorithm can be loaded from said software repository.

10. The device according to claim 9, wherein:
the hearing aid device parameters can be manually fine-tuned by the user or by an acoustic technician via said configuration unit; and
said configuration unit is programmed to record the response, to determine whether the modified hearing aid device parameters calculated by the computation algorithm were installed in the hearing aid device unchanged, or whether they were manually fine-tuned, and in a case of manual fine-tuning, to transfer the fine-tuned hearing aid device parameters in addition for archiving to said user database.

11. The device according to claim 9, wherein said evaluation algorithm is programmed to subject the data records contained in said user database to a cluster analysis to generate an extended rule for the computation algorithm.
